(19) United States
(12) Patent Application Publication
(10) Pub. No.: US 2009/0280991 A1
(43) Pub. Date: Nov. 12, 2009

(54) THREE-DIMENSIONAL FILTER AND TUNABLE FILTER APPARATUS

(75) Inventors: Kazunori Yamanaka, Kawasaki (JP); Akihiko Akasegawa, Kawasaki (JP); Keisuke Sato, Kawasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki-shi (JP)

(21) Appl. No.: 12/400,278

(22) Filed: Mar. 9, 2009

(30) Foreign Application Priority Data
May 8, 2008 (JP) 2008-122103

(51) Int. Cl. H01P 1/203; H01P 1/20

(52) U.S. Cl. 505/210; 333/202

(57) ABSTRACT

A three-dimensional filter includes a pair of superconductor films opposed to each other, and a three-dimensional resonator made of dielectric and situated between the superconductor films, wherein one of the superconductor films is movable relative to the three-dimensional resonator.

### CROSS-REFERENCE TO RELATED APPLICATIONS

The present application is based upon and claims the benefit of priority from the prior Japanese Patent Application No. 2008-122103 filed on 2008, May 8, with the Japanese Patent Office, the entire contents of which are incorporated herein by reference.

### FIELD

The disclosures herein generally relate to three-dimensional filters and tunable filter apparatuses using three-dimensional filters, and particularly relate to a three-dimensional filter and a tunable filter apparatus suitable for transmission of high frequency signals.

### BACKGROUND

A bandpass filter designed to be used for a conventional electrical power level may be utilized for a high frequency transmission system using a microwave band in a cognitive radio base station. To this end, it is desirable for a bandpass filter to tolerate high electrical power, to have a high Q factor, and to have a passband whose center frequency is variable over a wide range. It is not easy, however, to simultaneously satisfy these conditions.

Among RF filters for use in a base station using frequencies lower than a few GHz, a receiving filter that employs a signal power smaller than a few watts (W) may be one of a coaxial resonator type, a dielectric resonator type, and a superconductor resonator type. Such a receiving filter is not so much required to have a compact size as required to have high frequency selectivity. In term of frequency selectivity, a receiving filter equipped with a resonator circuit utilizing an oxide high-temperature superconductor film is advantageous in that it provides a high unloaded Q factor.

In the case of a superconductor-type transmitting filter using high electrical power, it is not easy to simultaneously achieve size compactness and proper electrical power characteristics (such as power tolerance). This presents a major challenge.

Among various superconducting filters, a filter having a planer-circuit structure has a resonator pattern formed of a superconductive material on a dielectric substrate. Attempts that have been made to achieve size compactness and improve power characteristics for such a planar-circuit-type superconducting filter include:
(a) forming the pattern of the superconductor film of the resonator circuit in a patch shape such as a circular shape or polygon shape to reduce the concentration of electrical current density; and
(b) attempting to control grain boundary, impurities, and the like to develop a higher-quality oxide high-temperature superconductor film.

It is also known to those skilled in the art to use a dielectric block in addition to the dielectric substrate on which a resonator pattern is formed. The provision of such a dielectric block can, to some extent, reduce the concentration of electrical current density on the superconductor.

Various studies on the three-dimensional structure of a superconducting filter have been made, including studies on a resonator as part of the basic structure and studies on application to an acceleration cavity. In the case of a resonator utilizing an oxide high-temperature superconductor, a high unloaded Q factor exceeding a few hundred thousands has been reported with regard to a structure in which superconductor films are provided at the top and bottom of a dielectric block (see Non-Patent Document 1 and Non-Patent Document 2, for example).

There has also been a report that studies a method of making an oxide-superconductor-based resonator tunable. As an example of such an attempt, it is known to those skilled in the art to use a configuration in which a dielectric plate is arranged above a planar resonator pattern formed of an oxide superconductor film, and the elevation of the dielectric plate is adjusted (see Patent Document 1, for example). In this configuration, the elevation of the dielectric film is controlled by adjusting a voltage applied to a piezoelectric element.

The tunable filter having a configuration as disclosed in publications tends to cause degradation in Q characteristics. Further, it remains to be a challenge to drive such a filter with a power higher than a few tens watts (W) in a configuration in which plural stages are utilized to achieve a frequency cutoff characteristic that is sufficiently steep for practical purposes.

It may be thus desirable to provide a tunable filter structure for a high-frequency filter that can provide improvements for the problems described above.

[Patent Document 1] Japanese Patent Application Publication No. 2002-204102

[Non-Patent Document 1] T. Hashimoto and Y. Kobayashi, “Frequency dependence measurements of surface resistance of superconductors using four modes in a sapphire rod resonator,” IEICE Trans. Electron., VOL. E86-C, No. 8, pp. 1721-1728, August 2003

[Non-Patent Document 2] T. Hashimoto and Y. Kobayashi, “Two-Sapphire-Rod-Resonator Method to Measure the Surface Resistance of High-Tc Superconductor Films,” IEICE Trans. Electron., Vol. E87-C, No. 5, pp. 681-688, May 2004

### SUMMARY

According to an aspect of the present disclosures, a three-dimensional filter includes a pair of superconductor films opposed to each other, and a three-dimensional resonator made of dielectric and situated between the superconductor films, wherein one of the superconductor films is movable relative to the three-dimensional resonator.

According to an aspect of the present disclosures, a tunable filter apparatus includes a conductor case, a three-dimensional filter including a pair of superconductor films opposed to each other and a three-dimensional resonator situated between the superconductor films, wherein one of the superconductor films is configured to be movable inside the conductor case, and first and second waveguides coupled to the conductor case along a direction perpendicular to a direction in which said one of the superconductor films is movable.

According to an aspect of the present disclosures, a tunable filter apparatus includes first and second conductor cases arranged adjacent to each other, an opening formed through adjacent faces of the first and second conductor cases, first and second three-dimensional filters placed in the first and second conductor cases, respectively, and a shutter configured to be inserted into a space between the first and second conductor cases to adjust an area size of the opening.

According to at least one embodiment, a three-dimensional filter and a tunable filter apparatus that are suitable for a microwave electrical power and have tunable frequency characteristics are provided.

The object and advantages of the embodiment will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is a schematic diagram of a tunable filter apparatus according to a first embodiment;

FIGS. 2A through 2C are drawings illustrating examples of the configuration of a three-dimensional filter used in the tunable filter apparatus illustrated in FIG. 1;

FIGS. 3A through 3C are schematic diagrams illustrating a simulation sample used to measure the frequency characteristics of the tunable filter apparatus of the first embodiment;

FIG. 4A is a graphic chart showing the characteristics (S₂₁) of the tunable filter of the first embodiment;

FIG. 4B is a graphic chart showing the characteristics (S₁₁) of the tunable filter of the first embodiment;

FIG. 5 is a schematic diagram of a two-stage tunable filter apparatus according to a second embodiment;

FIG. 6 is an illustrative drawing demonstrating the effect of tuning of the two-stage tunable filter apparatus of FIG. 5;

FIG. 7A is a drawing illustrating a simulation model sample of the two-stage tunable filter apparatus of the second embodiment;

FIG. 7B is a drawing illustrating the simulation model sample of the two-stage tunable filter apparatus of the second embodiment;

FIG. 7C is a drawing illustrating the simulation model sample of the two-stage tunable filter apparatus of the second embodiment;

FIG. 8A is a graphic chart illustrating characteristics observed when the thickness Dup of a superconductor-film-covered dielectric substrate is changed while keeping a coupling adjustment plate length Ls constant;

FIG. 8B is a graphic chart illustrating characteristics observed when the thickness Dup of the superconductor-film-covered dielectric substrate is changed while keeping the coupling adjustment plate length Ls constant;

FIG. 8C is a graphic chart illustrating characteristics observed when the thickness Dup of the superconductor-film-covered dielectric substrate is changed while keeping the coupling adjustment plate length Ls constant;

FIG. 9A is a graphic chart illustrating characteristics observed when the thickness Dup of a superconductor-film-covered dielectric substrate is kept constant while changing a coupling adjustment plate length Ls;

FIG. 9B is a graphic chart illustrating characteristics observed when the thickness Dup of the superconductor-film-covered dielectric substrate is kept constant while changing the coupling adjustment plate length Ls; and

FIG. 9C is a graphic chart illustrating characteristics observed when the thickness Dup of the superconductor-film-covered dielectric substrate is kept constant while changing the coupling adjustment plate length Ls.

### DESCRIPTION OF EMBODIMENTS

Prior to providing a description of preferred embodiments with the accompanying drawings, a description of a basic configuration will be given first. In the embodiments, a dielectric block is used as a three-dimensional resonator to constitute a three-dimensional filter. Superconductor films are arranged on the two sides of the dielectric block (i.e., three-dimensional resonator) such that one of the two sides is opposite to the other side along a line perpendicular to the signal travel direction, e.g., arranged over and under the dielectric block. The position of one of the superconductor films relative to the dielectric block is changed to achieve a variable resonance frequency.

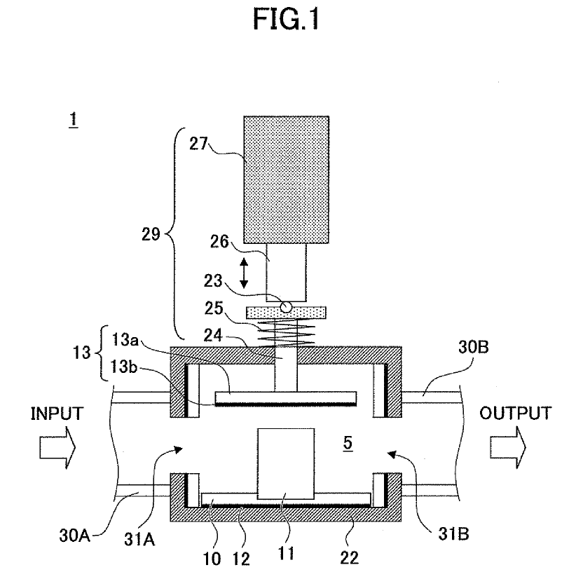

FIG. 1 is a schematic diagram of a tunable filter apparatus 1 according to a first embodiment. The tunable filter apparatus 1 includes a dielectric block 11 serving as a three-dimensional resonator, a superconductor film 12 situated under the dielectric block 11, and a superconductor film 13b movably situated over the dielectric block 11. In the example illustrated in FIG. 1, the position of the superconductor film 13b relative to the dielectric block 11 is adjustable by use of a drive mechanism 29.

The movable superconductor film 13b is formed on the surface of a dielectric substrate 13a that faces the dielectric block 11. The dielectric substrate 13a and the superconductor film 13b together constitute a superconductor-film-covered dielectric substrate 13. A superconductor film 12 situated under the dielectric block 11 is formed on the back surface of a dielectric substrate 10, and is fixed as to its position. A pair of the superconductor films 12 and 13b and the dielectric block 11 together constitute a three-dimensional filter 5. The three-dimensional filter 5 is placed inside a conductor case 22 made of copper, aluminum, an alloy thereof, or the like. The interior side walls of the conductor case 22 are preferably covered with superconductor-film-covered dielectric substrates. In the example illustrated in FIG. 1, signals (electromagnetic waves) travel in a direction indicated by arrows from the left-hand side to the right-hand side of the figure along the surface of the drawing sheet.

The superconductor-film-covered dielectric substrate 13 is coupled to the drive mechanism 29. The drive mechanism 29 includes a movable rod 24 penetrating through the conductor case 22 to couple to the superconductor-film-covered dielectric substrate 13, a spring 25, an actuator 27, an actuator movable part (displaceable part) 26, and a ball joint 23. The actuator 27 is an oil-less piezoelectric actuator (either of a rotating type or a linear type) utilizing PZT or the like. The ball joint 23 compensates for movement associated with axial misalignment between the actuator 27 and the movable rod 24. When a configuration that directly connects the actuator 27 to the movable rod 24 is employed, there is no need to provide the ball joint 23 and the spring 25.

The three-dimensional filter 5 illustrated in FIG. 1 is applicable to a transmitting filter, and waveguide tubes 30A and 30B are used to input and output signals into and from the three-dimensional filter 5, respectively. A signal (electromagnetic wave) propagating through the waveguide tube 30A passes through an opening 31A of the conductor case 22 to be incident on the dielectric block 11 where frequency components corresponding to the natural resonance frequency of the dielectric block 11 are extracted. A signal passing through the dielectric block 11 is output to the waveguide tube 30B through an opening 31B situated on the opposite side.

The waveguide tubes 30A and 30B may be a rectangular waveguide tube, and signals propagate therein in a TE mode. The electromagnetic wave entering the conductor case 22 through the opening 31A is placed in a TM mode at the dielectric block 11, so that the resonating electrical field is concentrated on the dielectric block 11. This suppresses the pinpoint concentration of electrical fields on the superconductor film 13b. This arrangement is thus more advantageous in terms of power tolerance compared with a planar-circuit-type superconductor resonator.

The opening 31A of the conductor case 22 is configured to be narrower than the cross-section (i.e., the cross-section perpendicular to the travel direction) of the waveguide tube 30A in order to cause the signal having propagated through the waveguide tube 30A to resonate upon entering the conductor case 22. Namely, only microwaves having particular frequencies satisfying the resonance conditions can enter the conductor case 22 through the opening 31A. The same applies to the opening 31B and the waveguide tube 30B on the output side.

The entirety of the tunable filter apparatus 1 is placed in a cooling case. The tunable filter apparatus 1 function as an electromagnetic-field resonator having a high unloaded Q factor at temperature sufficiently lower than a superconductivity critical temperature Tc.

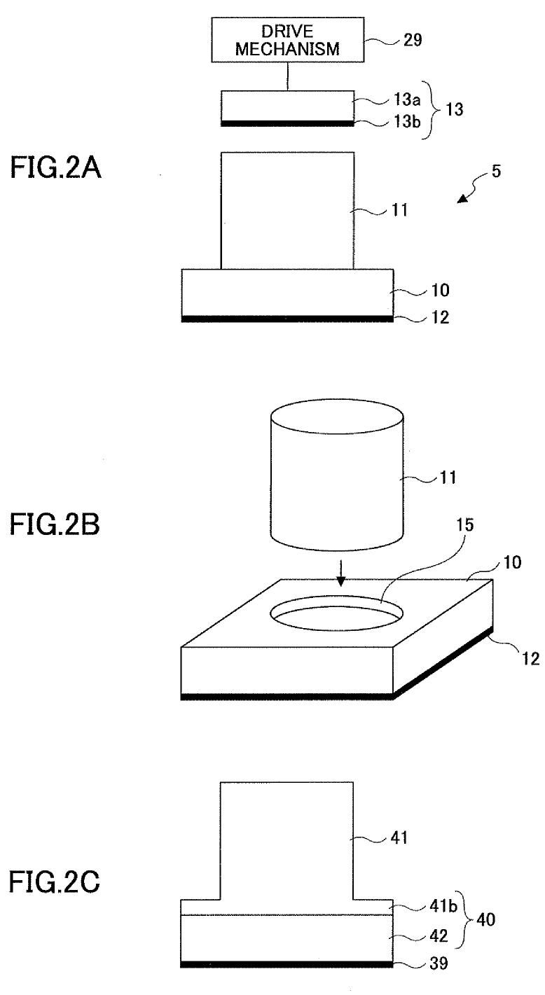

FIGS. 2A through 2C are drawings illustrating examples of the configuration of the three-dimensional filter 5. In an example illustrated in FIG. 2A, the superconductor film 12 that is positionally fixed is formed of a superconductor material such as YBCO (i.e., YBa₂CU₃O_{X}, x=6.90˜6.99) on the back surface of the dielectric substrate 10 made of MgO(100) crystal, LaAlO₃(100) crystal, or the like. The dielectric substrate 10 functions as a base platform of the three-dimensional filter 5. The dielectric block 11 is a cylindrical block projecting from the dielectric substrate 10, and may be made of alumina, sapphire, titania, or the like. The term “block” as used in the phrase “dielectric block 11” is intended to refer to a three-dimensional chunk in general. As previously described, the dielectric substrate 13a having the superconductor film 13b formed thereon is disposed over the dielectric block 11, and is connected to the drive mechanism 29.

FIG. 2B illustrates an example of assembling of the three-dimensional filter 5. A recess 15 is formed by use of ultrasound milling or the like in the dielectric substrate 10 made of MgO, LaAlO₃, or the like at the surface opposite to where the superconductor film 12 is disposed. The diameter of the recess 15 is substantially the same as the diameter of the cylindrical dielectric block 11. Fitting the dielectric block 11 into the recess 15 results in the main structure of the three-dimensional filter 5 being made as having a base platform and a projecting portion.

Alternately, as shown in FIG. 2C, a dielectric block 41 made by sintering alumina may be attached to a substrate 42 made of MgO(100). The back surface of the MgO substrate 42 is covered with a superconductor film 39. The dielectric block 41 has a flange 41b. The MgO substrate 42 and the flange 41b together constitute the base platform of the three-dimensional filter. It should be noted that an LaAlO₃(100) substrate may be used in place of the MgO(100) substrate 42. Alternatively, a layered structure made of YBCO/CeO₂/Al₂O₃ may be processed as to the Al₂O₃ part thereof to be made into a superconductor-film-covered three-dimensional filter. In this case, the thickness of the CeO₂ film may be approximately 50 nm.

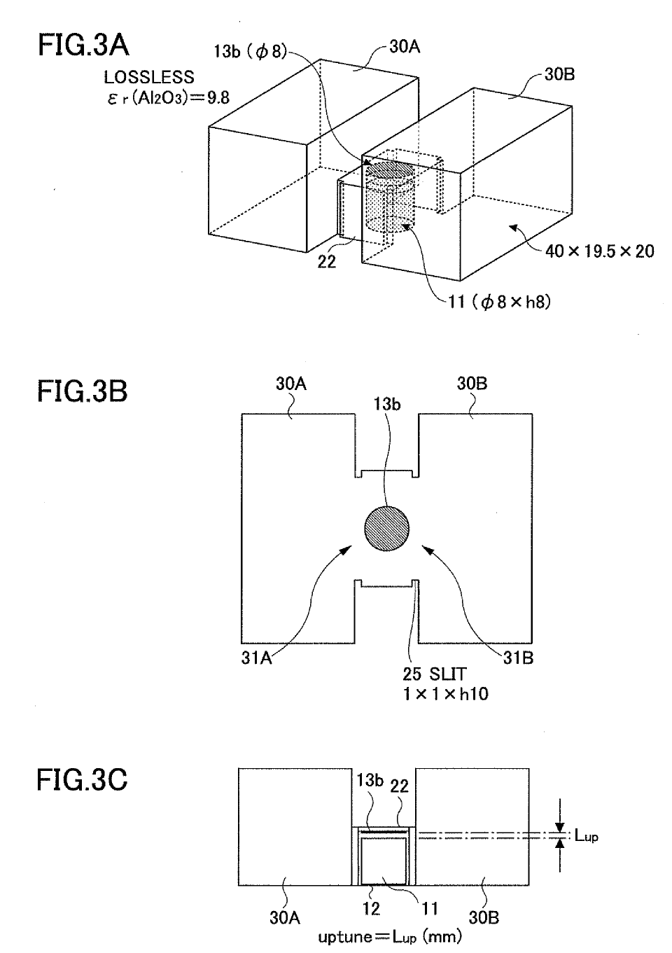

FIGS. 3A through 3B are schematic diagrams illustrating a simulation sample (model) used to measure the frequency characteristics of the tunable filter apparatus 1 having the configuration shown in FIG. 1. As illustrated in FIGS. 3A through 3C, the cylindrical-shape dielectric block 11 having a diameter of 8 mm and a height of 8 mm was placed in the conductor case 22, and the superconductor film 13b having a diameter of 8 mm was disposed over the dielectric block 11 in a movable manner. The superconductor film 12 was provided on the bottom surface of the dielectric block 11. The measurements of the conductor case 22 were 20 mm×11 mm×10 mm (height=10). The waveguide tubes 30A and 30B were placed on respective sides of the conductor case 22. Each of the waveguide tubes was 40 mm×19.5 mm×20 mm (height=20).

The dielectric block 11 was made of high purity Al₂O₃ having a permittivity of 9.8. The superconductor film 13b was an epitaxial film made of high-quality c-axis-oriented YBCO. Lossless conditions were assumed. The openings 31A and 31B of the conductor case 22 were made narrower by 1 mm on both sides in the width direction by use of slits 25 having a size of 1 mm×1 mm×10 mm. In an actual device, slidable plates to be inserted into the propagation path may be used in place of the slits 25, thereby making the width of the openings 31A and 31B adjustable.

Under the conditions as described above, the elevation of the superconductor film 13b was adjusted to change a distance Lup (uptune) between the dielectric block 11 and the superconductor film 13b. Lup was equal to 2 mm when the superconductor film 13b was lifted all the way up to the ceiling of the conductor case 22. Frequency characteristics were measured while gradually moving the superconductor film 13b closer to the dielectric block 11 from the initial position described above.

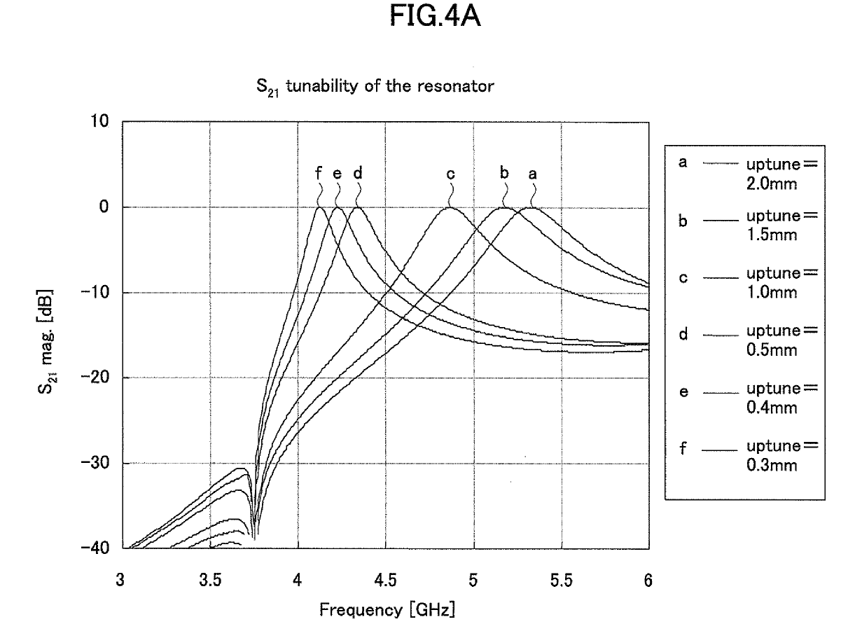

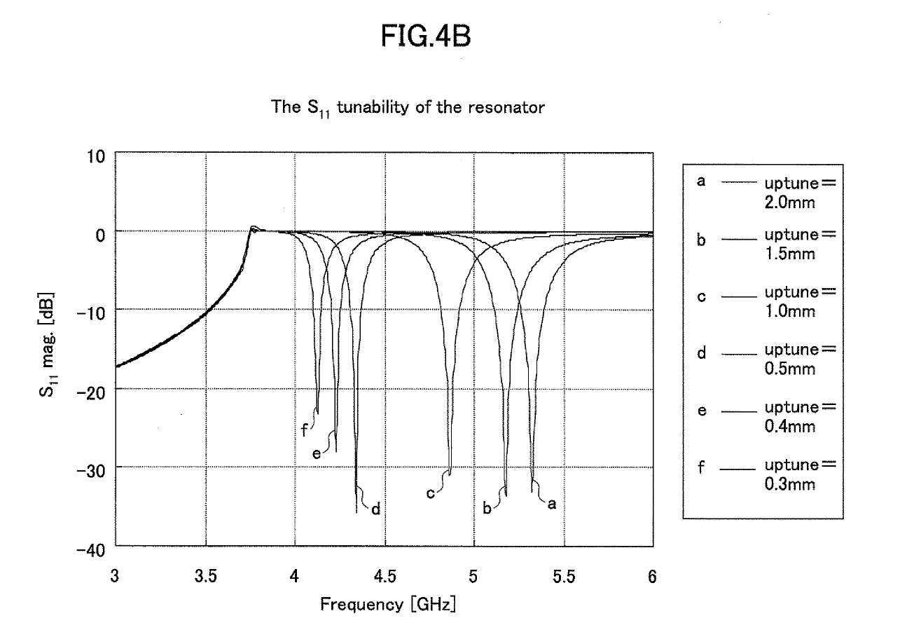

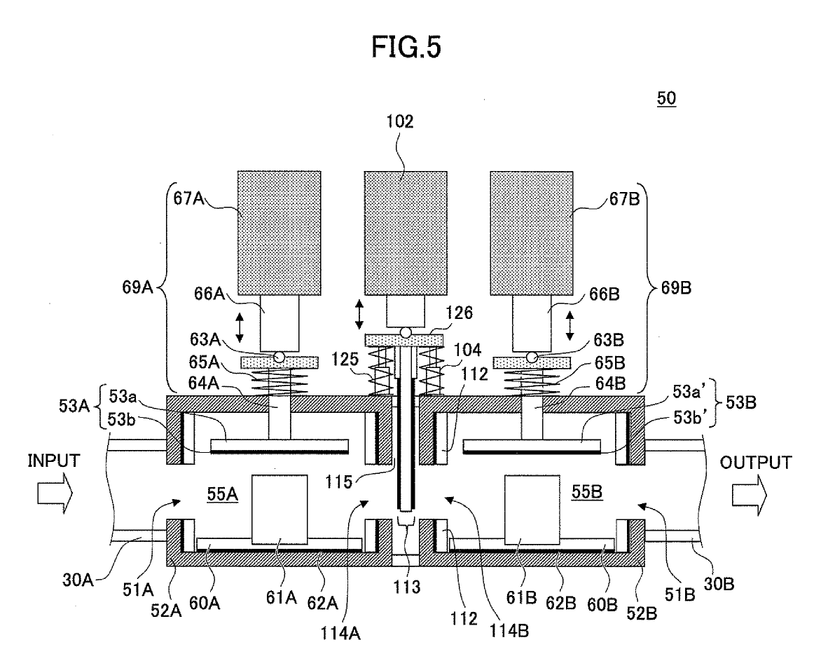

FIGS. 4A and 4B are graphic charts illustrating obtained measurements. FIG. 4A demonstrates S₂₁ (transmission) characteristics, and FIG. 4B demonstrates S₁₁ (reflection) characteristics. In FIGS. 4A and 4B, the obtained characteristic profiles exhibit a significant drop around 3.75 GHz. This is because the superconductor tunable filter apparatus used as a sample was designed for high frequencies in a 5-GHz band, and the waveguide tube 30 having a cross-section of 40 mm×19.5 mm did not transmit, by its characteristics, electromagnetic waves having frequencies smaller than 3.75 GHz.

As can be seen from FIGS. 4A and 4B, the center frequency shifts toward lower frequencies as the gap Lup between the superconductor film 13b and the dielectric block 11 is changed from 2 mm to 1.5 mm, 1.0 mm, 0.5 mm, 0.4 mm, 0.3 mm, successively. In this manner, provision can be made such that the center frequency of the passband is variable (tunable) over a wide range. Especially in the range from around 4.2 GHz to around 4.5 GHz, a fine adjustment of the center frequency can be made while maintaining the characteristics.

A design that uses the conditions of the sample apparatus shown in FIGS. 3A through 3C and FIGS. 4A and 4B and a resonance frequency of a 5-GHz band can attain a unloaded Q factor (Qu) higher than tens of thousands. Improvements on the quality of materials and the optimization of structure size and conditions will achieve Qu higher than one million.

In the following, a description will be given of a tunable filter apparatus 50 according to a second embodiment with reference to FIG. 5 in which the three-dimensional resonance filters as described in the first embodiment form plural stages connected in series. The example illustrated in FIG. 5 is a two-stage bandpass filter. The tunable filter apparatus 50 includes conductor cases 52A and 52B and three-dimensional filters 55A and 55B placed inside the respective conductor cases 52A and 52B.

As in the first embodiment, each three-dimensional filter 55A (or 55B) includes a dielectric block 61A (or 61B), a superconductor film 62A (or 62B) formed on the back surface of a dielectric substrate 60A (or 60B) situated on the lower side, and a superconductor film 53b (or 53b′) formed on a dielectric substrate 53a (or 53a′) disposed on the upper side to be vertically movable. The dielectric substrate 53a (or 53a′) and the superconductor film 53b (53b′) together constitute a superconductor-film-covered dielectric substrate 53A (or 53B). The material and configuration of the dielectric block 61A (or 61B) and the material of the superconductor film are the same as those used in the first embodiment, and a description thereof will be omitted.

The adjacent faces of the conductor cases 52A and 52B have orifices (openings) 114A and 114B, respectively. A slit 115 is provided between the conductor cases 52A and 52B. A shutter 113 is inserted into the slit 115 to adjust the area size of the orifices 114A and 114B. In the illustrated example, the shutter 113 is a dielectric substrate having both surfaces thereof covered with superconductor films.

A drive mechanism for driving the shutter 113 may include an oil-less piezoelectric actuator 102 such as PZT, a movable rod 126, guides 114 for guiding the vertical movement of the movable rod 126, and springs 125. The vertical movement of the shutter 113 makes it possible to adjust the strength of electromagnetic field coupling between the three-dimensional filters (i.e., between the dielectric blocks 61A and 61B serving as resonators). Such adjustment mechanism is not limited to the shutter 113 and the disclosed drive mechanism. Any type of adjustment mechanism that can change the electromagnetic field coupling through the orifices 114A and 114B may be used. In the example illustrated in FIG. 5, the shutter 113 is configured to be vertically movable to adjust a coupling through the orifices 114A and 114B. Alternatively, the shutter may be configured to be horizontally movable to change the effective area size of the orifices 114A and 114B.

In the same manner as in the first embodiment, the superconductor-film-covered dielectric substrates 53A and 53B held inside the respective conductor cases 52A and 52B are connected to respective drive mechanisms 69A and 69B to be adjustable as to their positions relative to the dielectric blocks 61A and 61B, respectively. This arrangement makes it possible to adjust and align the resonance frequencies of the three-dimensional filters. The configuration of the drive mechanisms 69A and 69B is the same as that used in the first embodiment. The drive mechanisms 69A and 69B mainly include movable rods 64A and 64B, springs 65A and 65B, ball joints 63A and 63B, piezoelectric actuators 67A and 67B, and actuator movable parts (displaceable parts) 66A and 66B, respectively. A detailed description of these elements will be omitted.

Openings 51A and 51B are provided on the opposite side of the conductor cases 52A and 52B to the side where the orifices 114A and 114B are provided, respectively. The openings 51A and 52B are connected to the waveguide tubes 30A and 30B, respectively. In the same manner as in the first embodiment, the interior side walls of the conductor cases 52A and 52B are covered with superconductor-film-covered dielectric substrates 112.

The flow of signals through the multi-stage filter of the second embodiment is as follows. A signal propagating through the waveguide tube 30A is incident on the dielectric block 61A serving as a first three-dimensional resonator. A signal corresponding to the natural resonance frequency of the dielectric block 61A passes through the dielectric block 61A. Part of the above-noted passing signal passes through the orifices 114A and 114B having the area size thereof adjusted by the shutter 113, and the remaining part is reflected. The signal propagating through the orifices 114A and 114B is incident on the dielectric block 61B serving as a second three-dimensional resonator. A signal corresponding to the natural resonance frequency of the dielectric block 61B passes through the opening 51B to enter the waveguide tube 30B.

As previously described, the resonance frequencies of the first and second three-dimensional resonators (dielectric blocks) 61A and 61B are adjusted to be equal to each other by controlling the positions of the superconductor films 53b and 53b′. Further, resonating electromagnetic field coupling between the dielectric blocks 61A and 61B is adjusted by controlling the area size of the orifices 114A and 114B through the adjustment of the position of the shutter 113, thereby adjusting the bandwidth. In this manner, the two-stage bandbass filter according to the second embodiment is provided with a tunable center frequency and a tunable bandwidth.

The entirety of such two-stage bandpass filter is placed in a vacuum cooling chamber (not shown). Each of the dielectric blocks 61A and 61B functions as an electromagnetic-field resonator having a high unloaded Q factor at temperature sufficiently lower than a superconductivity critical temperature Tc. When the dielectric blocks 61A and 61B are formed as a cylinder, the electrical field of the incoming electromagnetic waves will be concentrated, thereby preventing the pinpoint concentration of electrical fields on the superconductor films.

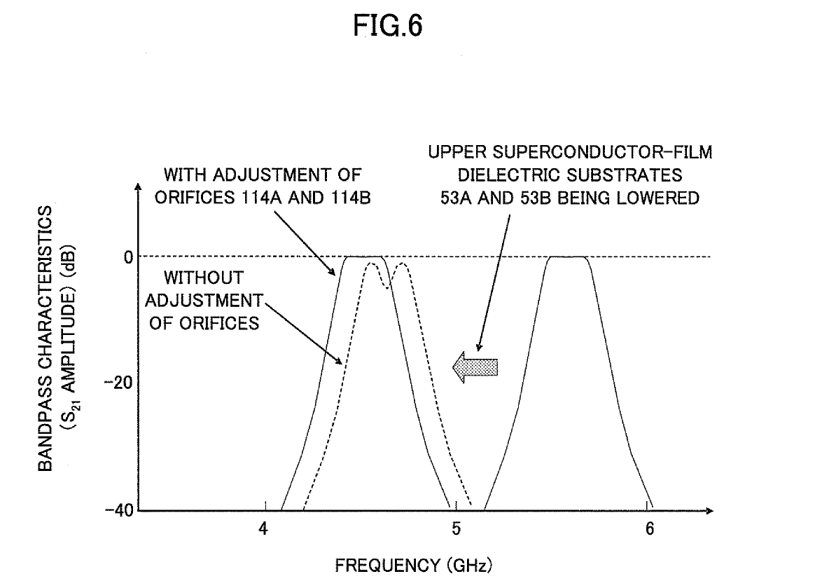

FIG. 6 is an illustrative drawing demonstrating the effect of tuning of the tunable filter apparatus 50 according to the second embodiment. Without adjusting a coupling through the orifices 114A and 114B, the elevations of the superconductor-film-covered dielectric substrates 53A and 53B may be lowered by the same shift amount from their upper limit positions over the first and second three-dimensional resonators (dielectric blocks) 61A and 61B, respectively. In such a case, the peak is divided to produce a double-peaked curve as illustrated by the dotted curved line. The coupling area size of the orifices 114A and 114B may then be widened (by raising the shutter 113 in the case of the second embodiment) to strengthen a coupling between the dielectric blocks 61A and 61B. This results in the double-peaked dotted-line curve being changed into a single-peaked curve as shown by a solid curved line.

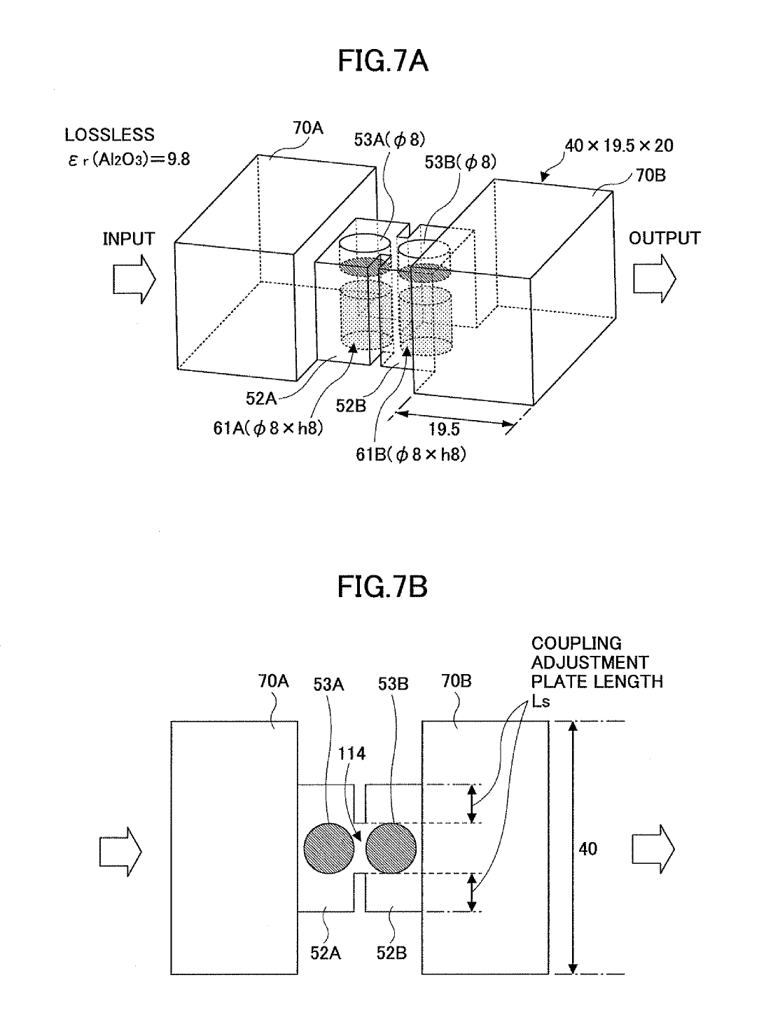

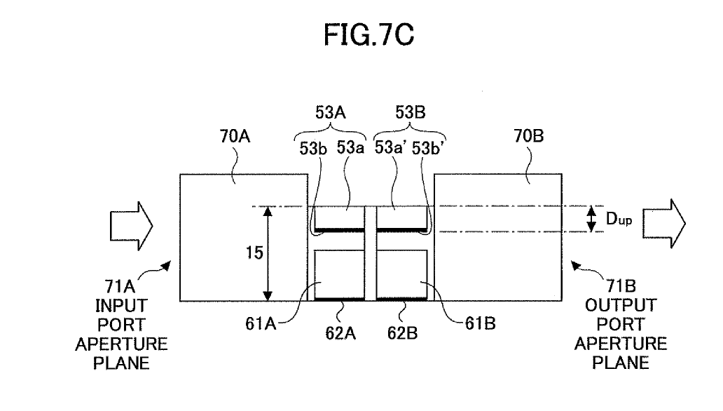

FIGS. 7A through 7C are drawings illustrating a simulation sample (model) of the two-stage three-dimensional filter of the second embodiment. Waveguide tubes 70A and 70B each having a size of 40 mm×19.5 mm×20 mm were connected to the input side of the conductor case 52A and the output side of the conductor case 52B, respectively. An opening 71A of the waveguide tube 70A served as an input port, and an opening 71B of the waveguide tube 70B served as an output port.

The cylindrical dielectric blocks 61A and 61B each having a diameter of 8 mm and a height of 8 mm were placed in the conductor cases 52A and 52B, respectively. The height of the conductor cases 52A and 52B was 15 mm. The superconductor-film-covered dielectric substrates 53A and 53B were situated over the dielectric blocks 61A and 61B, respectively. The superconductor films 62A and 62B were provided on the bottom surfaces of the dielectric blocks 61A and 61B, respectively.

The thickness of the superconductor-film-covered dielectric substrate 53A (53B), i.e., the distance between the upper surface of the dielectric substrate 53a (53a′) and the lower surface of the superconductor film 53b (53b′) (i.e., the surface that faces the dielectric block 61A (61B)), was denoted as Dup. Dup was changed to adjust the distance between the superconductor film 53b (53b′) and the dielectric block 61A (61B).

Coupling adjustment plates (corresponding to the shutter 113 illustrated in FIG. 5) were inserted into the space between the two conductor cases 52A and 52B from both sides from the horizontal direction to adjust the width (i.e., area size) of the orifice 114. The length of the part of each coupling adjustment plate that was inserted into the space was denoted as a coupling adjustment plate length Ls.

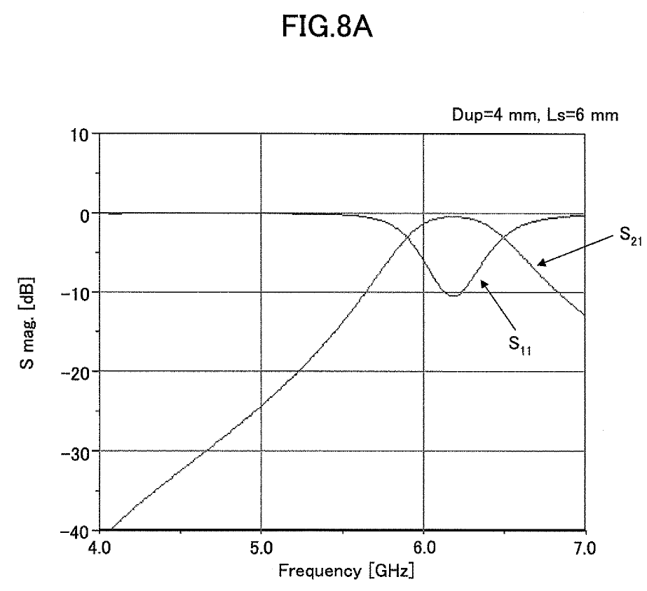

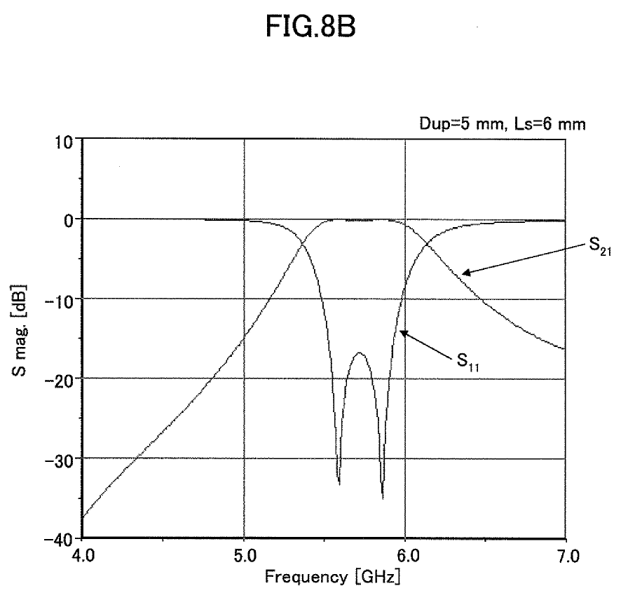

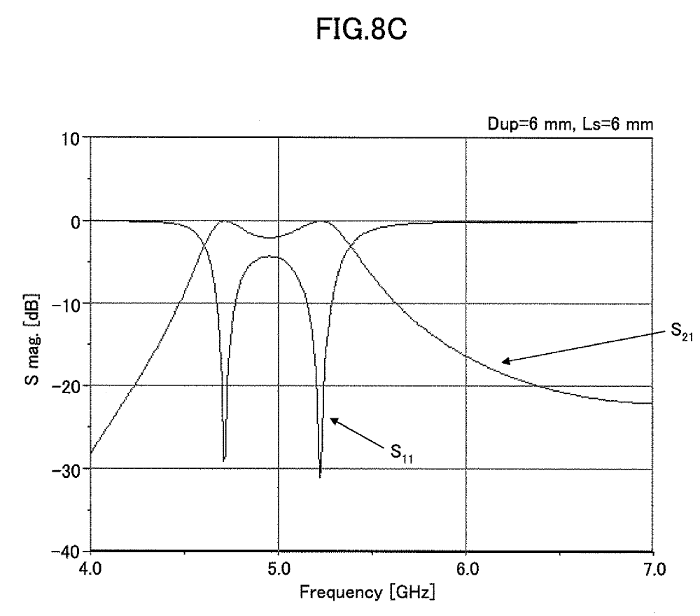

FIGS. 8A through 8C are graphic charts illustrating changes in frequency characteristics observed when the thickness Dup of the superconductor-film-covered dielectric substrates 53A and 53B were changed from 4 mm to 5 mm and then to 6 mm to bring the superconductor films 53b and 53b′ closer to the dielectric blocks 61A and 61B, respectively, while maintaining the coupling adjustment plate length Ls at 6 mm in the simulation model illustrated in FIGS. 7A through 7C. As the distance between the superconductor films 53b and 53b′ and the dielectric blocks 61A and 61B decreases, filter frequency characteristics appear increasingly prominently, and the center frequency shifts toward lower frequencies, with decreased reflection at the desired band (e.g., a 5-GHz band in this example).

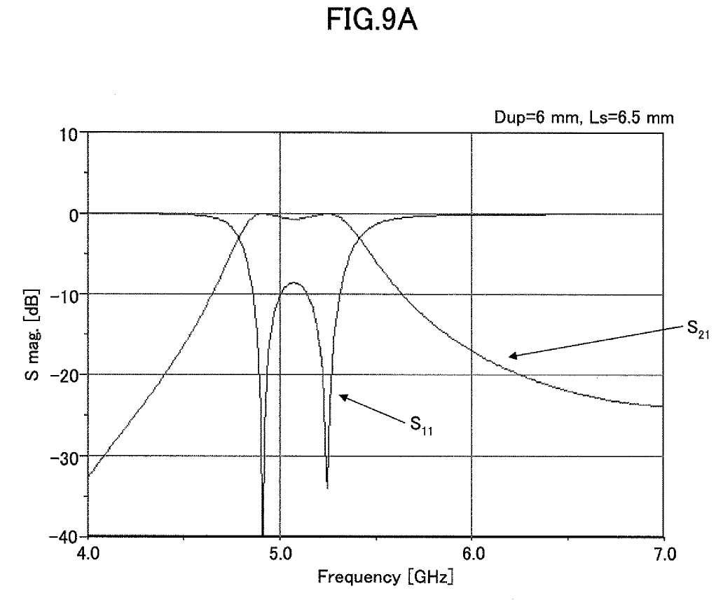

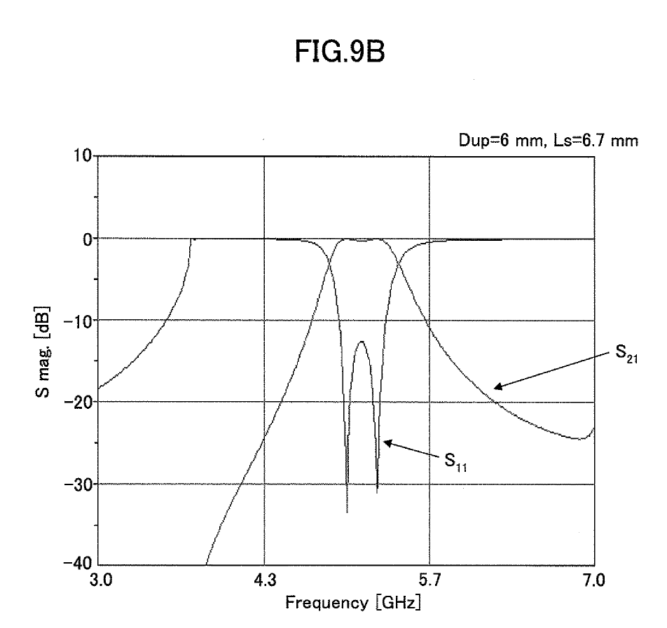

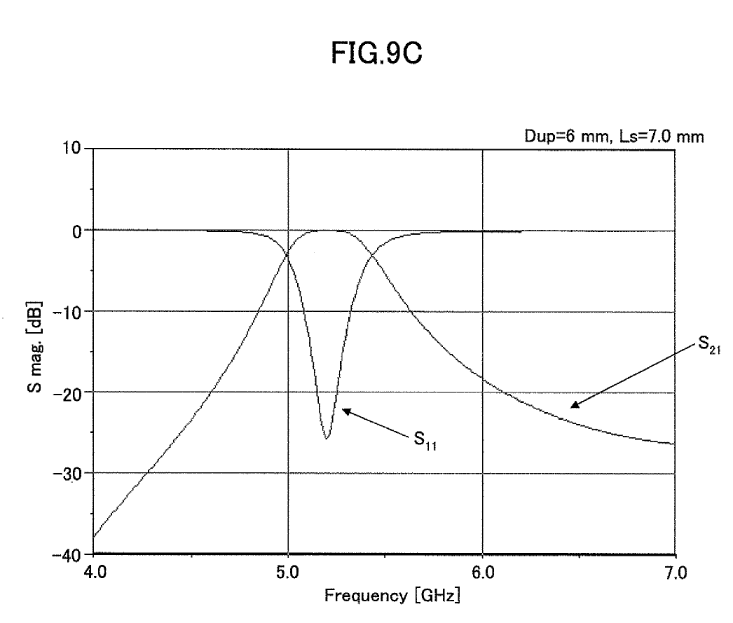

FIGS. 9A through 9C are graphic charts illustrating changes in frequency characteristics observed when the coupling adjustment plate length Ls was changed from 6.5 mm to 6.7 mm and then to 7.0 mm by narrowing the width of the orifice 114 while maintaining the thickness Dup of the superconductor-film-covered dielectric substrates 53A and 53B fixed at 6 mm in the simulation model illustrated in FIGS. 7A through 7C. As the width of the orifice 114 is decreased by changing the coupling adjustment plate length Ls from 6.5 mm to 6.7 mm, the signal bandwidth is decreased. An excessive narrowing, however, results in the weakening of filter characteristics as shown in FIG. 9C.

In FIG. 9B, the lower frequency portion of the S₂₁ characteristics exhibits a drop. This is because the simulation sample was designed for high frequencies in a 5-GHz band, and the waveguide tubes 70A and 70B each having a cross-section of 40 mm×19.5 mm did not transmit, by their characteristics, electromagnetic waves having frequencies smaller than 3.75 GHz.

In this manner, the two-stage three-dimensional filter configuration can adjust at least one of the center frequency and the bandwidth during the ongoing operation of the tunable filter apparatus 50. Such adjustment can be made by adjusting at least one of the position of the superconductor films 53b and 53b′ relative to the respective dielectric blocks 61A and 61B and the width of the orifice situated between the three-dimensional filters. Although the embodiments have been described heretofore by referring to particular examples of configurations, the present invention is not limited to these examples. For example, the dielectric blocks 11, 61A, and 61B are not limited to a cylindrical shape, but may be a rectangular solid. The superconductor film is not limited to YBCO, but may be a metal superconductor such as Nb, Nb—Ti, Nb₃Sn, Pb, or Pb alloy, or may be an oxide high-temperature superconductor such as RBCO (R: Nd, Sm, Ho, Gd) or BSCCO. The dielectric block used as a resonator may be made of crystal including an oxide of one or more materials selected from Mg, Al, Ti, and Sr, or may be made of ceramic material.

The embodiments described heretofore provide the following advantages:
the use of a three-dimensional filter including a superconductor film having small conduction loss and a dielectric block resonator having small dielectric loss can provide a high unloaded Q factor (Qu);
the use of a configuration in which resonating electrical fields concentrate on the dielectric block can suppress the pinpoint concentration of electromagnetic fields on the superconductor film, thereby providing better power tolerance compared with a planar-circuit-type superconductor resonator; and
tunable bandpass characteristics are obtained to allow the adjustment of the center frequency and width of the passband.

Such a three-dimensional filter and tunable filter apparatus 1 are suitable for the sharing of radio waves that has been gradually put into practical use in radio communication systems, i.e., suitable for efficient utilization of radio resources that actively utilizes available frequencies.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present inventions have been described in detail, it should be understood that the various changes, substitutions, and alterations could be made hereto without departing from the spirit and scope of the invention.

What is claimed is:

1. A three-dimensional filter, comprising:
a pair of superconductor films opposed to each other; and
a three-dimensional resonator made of dielectric and situated between the superconductor films,
wherein one of the superconductor films is movable relative to the three-dimensional resonator.

2. The three-dimensional filter as claimed in claim 1, wherein the superconductor films are arranged on both sides of the three-dimensional resonator, respectively, across a signal propagation path.

3. The three-dimensional filter as claimed in claim 1, further comprising:
a first dielectric substrate situated over the three-dimensional resonator; and
a second dielectric substrate situated under the three-dimensional resonator,
wherein said one of the superconductor films is formed on a surface of the first dielectric substrate that faces the three-dimensional resonator, and another one of the superconductor films is formed on a surface of the second dielectric substrate on an opposite side to the three-dimensional resonator.

4. The three-dimensional filter as claimed in claim 3, wherein the second dielectric substrate has a recess, into which the three-dimensional resonator is engaged.

5. The three-dimensional filter as claimed in claim 3, further comprising a drive mechanism coupled to the first dielectric substrate.

6. The three-dimensional filter as claimed in claim 1, wherein the three-dimensional resonator is a dielectric block having a cylindrical shape or rectangular solid shape.

7. A tunable filter apparatus, comprising:
a conductor case;
a three-dimensional filter including a pair of superconductor films opposed to each other and a three-dimensional resonator situated between the superconductor films, wherein one of the superconductor films is configured to be movable relative to the three-dimensional resonator; and
first and second waveguides coupled to the conductor case along a direction perpendicular to a direction in which said one of the superconductor films is movable.

8. The tunable filter apparatus as claimed in claim 7, wherein the conductor case has openings on faces thereof to which the first and second waveguides are coupled,
and includes a slidable plate configured to be inserted into one of the openings from a horizontal direction.

9. The tunable filter apparatus as claimed in claim 7, further comprising a drive mechanism configured to change a position of said one of the superconductor films relative to the three-dimensional resonator.

10. A tunable filter apparatus, comprising:
first and second conductor cases arranged adjacent to each other;
an opening formed through adjacent faces of the first and second conductor cases;
first and second three-dimensional filters placed in the first and second conductor cases, respectively; and
a shutter configured to be inserted into a space between the first and second conductor cases to adjust an area size of the opening.

11. The tunable filter apparatus as claimed in claim 10, wherein each of the first and second three-dimensional filters includes a pair of superconductor films and a three-dimensional resonator situated between the superconductor films, wherein one of the superconductor films is configured to be movable relative to the three-dimensional resonator.

12. The tunable filter apparatus as claimed in claim 10, further comprising:
a first waveguide tube coupled to the first conductor case on an opposite side to the opening; and
a second waveguide tube coupled to the second conductor case on an opposite side to the opening,
wherein a movable direction of said one of the superconductor films in each of the three-dimensional filters is perpendicular to a direction in which the first and second waveguide tubes extend.
